(19) United States
(12) Patent Application Publication
(10) Pub. No.: US 2007/0272707 A1
(43) Pub. Date: Nov. 29, 2007

(54) Autonomous apparatus for painting applications

(76) Inventors: Ernesto Fabio Peralta, Buenos Aires (AR); Jorge Silvic Rossen, Buenos Aires (AR); Igor Sas, Buenos Aires (AR); Leonardo Dante Salama, Buenos Aires (AR)

Correspondence Address: Clifford Kraft, 320 Robin Hill Dr., Naperville, IL, 60540, US

(21) Appl. No.: 11/803,717

(22) Filed: May 15, 2007

(30) Foreign Application Priority Data
May 15, 2006 (AR) P20060101939

(51) Int. Cl. B67D 5/56

(52) U.S. Cl. 222/129; 222/608; 222/189.06; 239/146

(57) ABSTRACT

An autonomous equipment for the application of paints, utilizable with rechargeable rolls or spraying pistols, and that covers a portable tank that has two separate storage chambers, one to keep the paint and the other one to keep the operative components of the equipment, such as a bomb, a motor and the elements for control and feeding.

This application claims priority to Argentine application number: 20060101939 filed May 15, 2006. Application 20060101939 is hereby incorporated by reference.

### INVENTION STATE-OF-THE-ART

### Invention Field

The present invention is linked to the field of the devices and equipment used for the paint application, preferably, the invention is related to the professional area where the output, application quality and work conditions impose limitations that are difficult to be met and, more specifically, the invention is referred to an autonomous equipment for the paint application that allows it to feed, in an automatic controlled way or in a manual way, the paint applicator that is being used, be either a pistol, a roller and/or any other appropriate applicator, allowing a better use and output of the paint.

### DESCRIPTION OF THE PREVIOUS STATE-OF-THE-ART

Aside from the classic and known paint applicators such as rollers, which get soaked or recharged with paint, as well as the pistols that provide paint through spraying, for example, pressure air pistols, both of the suction type as well as the upper side type when the job has to do with the paint application on large surfaces or under certain work conditions, for example, at high level; when it is necessary to paint external walls of high buildings, such applicators need to work in conjunction with other components. This is why the equipment denominated “airless” are known, which run with a piston or diaphragm compressor and reach high pressure values, for example, 200 bars and, consequently, need powerful motors such as ¾ Hp. In general, this type of equipment is utilized with application pistols, supplying the paint through pressure along a feeding hose for the pistol. However, the wind, that is an important factor for height works, makes that the use of pistols is discarded due to the large quantity of sprayed paint that is scattered and gets lost.

Consequently, this compressor equipment is utilized in order to feed rollers that are fed with paint in their internal chambers. However, the high value of the pressure, being put on the paint, causes spillage and loss of the same through the roller. For information purposes, we can state that a roller, that is designed in order to be able to work with a paint feeding pressure of 500 thousand bars, is normally fed by a compressor, which is able to generate the aforementioned 200 pressure bars. In turn, the said compressors are fed with electrical power from the commercial network and, because of that, it is necessary to have available close by and safe connections, avoiding long stretches of cables and hoses with joints. Presently, the said case is intended to be solved with longer, high pressure hoses that use to reach up to a 15 meter length.

In the case of spraying works at high level, the handling of heavy equipment becomes a limitation for the application conditions and the use comfortableness as the person, who is in charge, is obliged to take into account the diverse elements that are involved in the task such as the compressor, the electrical connections, the hose, the couplings, both electrical and hydraulic, and the application roller or pistol.

Due to the current status of the technique, it would be thus convenient to have available an equipment for the sprayed liquid application, preferably paint, that could supply the necessary pressure, be either to feed a painting roller or a pistol and that is autonomous as regards to its feeding and that is portable so it can be carried and operated in non-conventional cases such as works at high level, secluded areas, sanitary areas, etc.

### BRIEF DESCRIPTION OF THE INVENTION

Consequently, it is a purpose of the present invention to provide an autonomous equipment for the liquid products application, preferably paints, being utilizable with rechargeable rollers or spraying pistols, and that encompasses a portable tank that has two separate, closed chambers, one for keeping the paint and the other one for storing the operative equipment components such as a bomb, a motor and the control and feeding elements.

It is also another purpose of the present invention to provide an autonomous equipment for fluid products application such as paints, preferably of professional use, of the type that is connected to a paint applicator such as a roller, a sprayer or something similar, in order to spread out the paint over the surface to be painted, where the equipment encompasses:
a tank that forms a first paint containing chamber that shows a throat for the paint charging;
an internal tank compartment that forms a second closed chamber;
a paint suctioning/inpulse bomb that has a plug connected to a fishing tube that exits from the said closed, internal compartment and it enters into the said paint containing chamber, having on the bomb a paint outlet connected to a paint feeding hose that, in turn, is connected to the said paint applicator;
at least, an impulse motor connected to the said bomb;
an energy feeding source; and
a control circuit connected to the said source and the aforementioned motor, being the said bomb, regarding at least one impulse motor, the said control circuit and the said feeding source placed into the said second closed chamber of the internal tank compartment.

It is also another purpose of the present invention to provide an autonomous and portable paint equipment, preferably for professional use, and that it can operate both with paint rollers with internal feeding as well as with pressure air pistols both of the suction type and the upper charge type, supplying the paint through a hose and being propelled by means of an appropriate bomb of peristaltic type, driven by a continuous current, low tension motor, which is fed through a rechargeable battery of 12 or 24 volts that allows to achieve significant time savings in the works related to large surfaces as it avoids, in the case of the roller, the periodic task of soaking it and flowing it off, as it so happens with the conventional ones and, in the case of the pistols, the repeated recharging of their—

recipients, also avoiding the known spillage that makes it necessary to place protection covers, thus eliminating the final cleaning tasks, what helps for the total time saving.

### BRIEF DESCRIPTION OF THE DESIGNS

For better clearness and understanding of the present invention purpose, the same one has been illustrated on several figures, on which the invention has been shown as per the preferred implementation way, everything as an example, where:

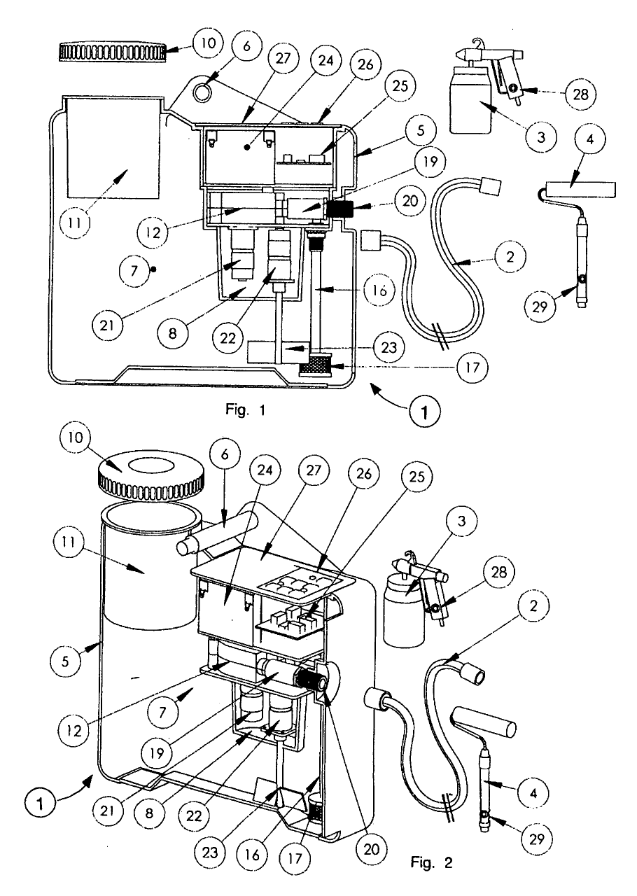

FIG. 1 is a transversal equipment cut, in accordance with the preferred implementation of the invention;

FIG. 2 is a perspective view of FIG. 1 equipment, as from an upper angle, as a cut and partially by parts/components breakdown;

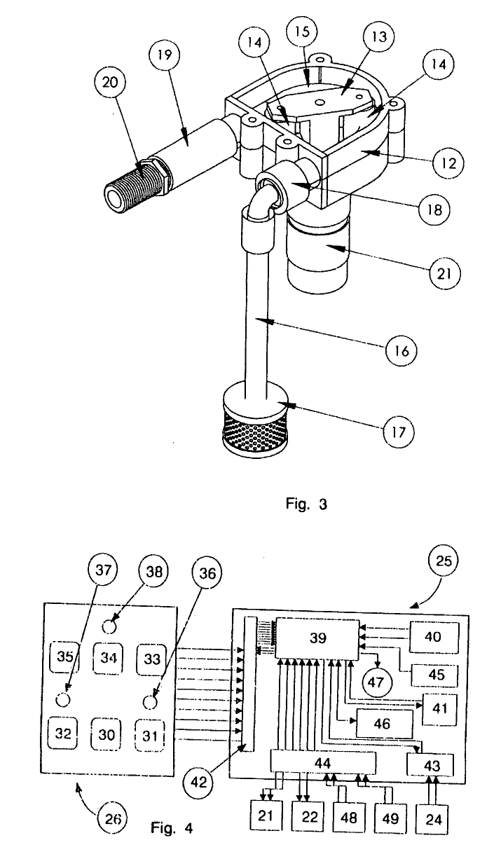

FIG. 3 is a perspective view of the peristaltic bomb being utilized in the equipment, in accordance with the invention, and

FIG. 4 is a block diagram of a control electronic circuit and its corresponding keyboard in accordance with the invention.

### DETAILED DESCRIPTION OF THE INVENTION

Referring, at this time, to Figures, we see that the invention encompasses an autonomous equipment for the paint application, as indicated with the general reference number 1, and it can be connected, by means of a hose 2, to a paint applicator, as generically indicated on FIG. 2, which can be a spraying pistol 3, a roller 4, or any other similar applicator instrument that operates with a paint supply originating in the equipment 1 and is able to spread out the paint over the surface to be painted. Although we will refer to paint, it is worth pointing out that the present equipment has the capability for applying any liquid product or of similar fluency.

The invention equipment encompasses a tank 5, which is preferably made of a light material such as plastic, aluminum or other similar ones in a way to form a closed containing chamber for liquids, of portable weight and size, which, as per our preferred implementation, it is provided with a transportation handle 6. The tank is designed with a first chamber 7 for keeping the paint and a second closed chamber 8 that has the purpose of storing the equipment components as it will be seen henceforward. In order to allow the paint filling into the tank 1 and more specifically into the chamber 7, the tank shows a charging throat 9 that is provided with a cap 10 and a removable filter 11.

Into the closed chamber 8, a paint suctioning/propelling bomb 12 is provided, preferably a peristaltic bomb that, as it can be seen on FIG. 3, it encompasses a rotor 13 with two or more tightening rollers 14 that run, on a replaceable, flexible tubing, the crushable conduit 15 in order to take the paint that is kept into the chamber 7, to carry it along the tubing and to make it to go up along the fishing tube 16, that passes through the wall of the chamber 8, in order to place it with a lower end near the tank bottom, where it includes a removable filter 17. The conduit plug 15 can be connected to the tube 16 by means of a connector 18. The conduit 15 is linked, by means of the connector 19, to the exit tube 20 that can be connected, with removal possibility, to the feeding hose 2, which, as it was schematically shown on FIG. 2, can be connected, at its turn, to the paint applicator, be the spraying pistol or the roller. The equipment 1 is provided with at least an impulse motor and, more specifically, a first impulse motor 21 that is connected to the bomb 12 for its driving.

A second impulse motor is connected to a palettes mixer 23 that can be started in order to mix the paint in a manual way, whenever it is wanted, or in an automatic way. Both the motor 22 and the motor 21 can be direct current, propelling/impulse, low tension motors. An energy source, such as a battery 24, preferably of 12 or 24 Volts and being rechargeable, is connected to both motors for their feeding. Additionally, these motors, together with the battery, are connected to a control circuit that preferably encompasses a control electronic circuit board 25 placed into the aforementioned second closed chamber 8 of the internal tank compartment, together with the other components, that is, the bomb 12, the motors 21 and 22 and the battery 24. The chamber 8 is crowned by an operation panel 26 and a cap 27 that makes the panel 26 accessible to the operator. The operation panel 26 is connected to the said electronic circuit board 25 and it can be formed by a hermetic keyboard with soft touch driving keys.

In accordance with an alternate implementation, one or all of the keyboard commands 26, can be directly provided at a point of the feeding hose or at a point of the paint applicator handle, either at the pistol handle 3 as it is indicated with the reference number 28, or at the roller handle 4 as it is indicated with the reference 29 on FIG. 2. Additionally, the feeding hose 2 can be connected to an extension tube, not shown, provided with an internal conduit for carrying the paint in a way to reduce the weight of the same one when the job must reach significant heights.

More specifically, if it is wanted to utilize the roller at a significant height, an extension tube can be used, being formed by a plastic or aluminum tube that can be coupled to the paint feeding hose or, just in case, by a similar tube, but being longer, that operates as an extension and it makes possible more reach regarding height. A tube of less diameter is placed in the interior of the tube and the extensions, through which the paint flows, avoiding that the whole cavity is filled with paint, having the inefficiency of making useless a higher paint quantity, longer priming time and more weight of the resulting spear. The internal tube is separated from the external tube by separators such as rubber rings.

Regarding the pulser or the controls, that are placed at the hose or at the handle, the same ones can be useful for the driving of various types of equipment remote operation. For example, the pulser allows to drive the equipment motor as per intervals long enough in order to provide the paint doses that are needed as long as the work requires it. The pulser will be connected to the motor by means of a control plaque and the link can be wired or wireless.

As a way of another example, the motor 21 and the bomb can work in a direct operation mode, where the paint is fed to the applicator, and they can run in a reverse operation mode, where the paint is recovered from the applicator. In other words, in the direct mode, the rotation of the motor and the bomb sends paint from the tank towards the hose and from this one to the roller or the pistol that is coupled at the other side. In the reverse mode, the rotation of the motor and the bomb is reversed in a way to recover the paint towards the tank as a previous step to the cleaning of the elements after having finished the job. This last mode is particularly useful when an extension tube or a feeding hose has been utilized and it is necessary to recover all of the paint that has remained at that part of the tube or the hose. In order to complement the operation of those two modes, the keyboard 26 or the controls 28 or 29 are provided with a driver of the direct mode for a first time period and a direct mode activator pulser in a second moment, where the first moment corresponds to the equipment priming and the second time period has to do with the paint supply. The aforementioned driver can be a retention key or it can encompass a pulser with pre-adjustable timing function. The pulser can cover a continuing pressure pulser or a pulser with pre-adjustable timing function.

In addition, two time periods are recognized in the direct mode. In the first time period, that is when the job must be started, it is required to perform the priming of the whole equipment (admission tube, bomb, hose, handle, extension and roller or, if not, pistol recipient). This task requires some time that is dependent upon the paint viscosity and the hose length; in order to perform it, there is a retention key or, if not, a priming pulser 33 with pre-adjustable timing function for a time lapse t1. In a second time period, when the equipment is already primed, and from the start to the end of the job, uniform paint doses are required, being provided to cover what the application device is consuming. For that purpose, there is another dose applicator pulser 34 at the control panel, that operates in a parallel way with the one that is placed at the handle of the application device (roller or pistol), being that the said pulsers can operate either by sustainable continuing pressure during the period that is wanted or, if not, with pre-adjustable temporization function for a t2 time lapse, being shorter than the priming function. In this way, it is reduced: the time needed for painting and the time to clean the equipment as soon as the job is finished. On the other hand, as spillage is not produced, the time for floor masking is saved or, if not, for cleaning.

As an additional feature, the equipment is provided with warning alarm for the operator. In fact, the control circuit, or electronic circuit board 25 shows a first alarm corresponding to a first charge status of the said battery and a second alarm corresponding to a second battery charge status, where the aforementioned first charge status corresponds to a remaining charge for a day's work of operation, while the said second charge status corresponds to an incoming battery depletion. More specifically, the control board provides the start up and stopping function of the motor, what allows to control the battery charge status and it warns, in a sonorous way, about the need of its recharge by means of a buzzer 47, and in a luminous way through a light emitter diode 38 in two different moments and modes. The diode 38 is preferably of the type that can emit three colors of light, yellow, red and green. In a first moment, through a sonorous signal for a predefined time lapse, it warns about that the battery will have to be recharged by the end of the day's work; in our preferred example, the time duration can be 20 seconds, in addition this acoustic signal is accompanied by an intermittent, luminous signal, of red color, at the light emitter diode 38. In the second moment, the sonorous signal warns that the recharge is peremptory by using a more insistent sound at the buzzer 47, being accompanied by a continuing luminous signal, of red color, at the light emitter diode 38, blocking the running of the motor in order to avoid that the battery depletion becomes more serious and it shortens the useful life of the same one; this alarm can be stopped by utilizing the Connect/Disconnect key 30 or, if not, by connecting the external source for battery recharge.

For its part, the battery 24 can be connected, with removal possibility, to a source-charger that, at its turn, it is connected to an alternating current feeding line, for example of 110 V. or 220 V. At the time of connecting the said source charger, the battery is being charged while the equipment running is enabled, which, at that time, is fed directly by the source.

During the battery charging, the luminous indicator 38 turns on in intermittent mode of yellow color, confirming the battery charge status 24, and it turns its color to green as soon as the battery has completed its charge.

For all of these functions, as described above, the electronic circuit board 25 and the operation panel 26, as it is shown on FIG. 4, are formed by a central microprocessor 39, being in charge of coordinating all of the logical functions of the other components, which receives information about the remote pulser status 28 or 29 through the radio-frequency receptor 40; in addition, it has a connector 41, preferably a RS-232 lock gate that allows linking the equipment to the external side regarding the circuit programming, for example, by means of a computer. The battery 24 is linked, through the battery connector 43, to the microprocessor 39 that is in charge of establishing the status.

In addition, the electronic circuit board is provided with a multiple connector that drives the bomb motor 21 and the mixer motor 22 and, at the same time, it receives information from a pressure sensor 48 and a crack detecting sensor 49 that is in charge of verifying the status of the bomb elastic tube 15.

In addition, an internal clock is available 45, being in charge of providing the time reference and a memory 46, EPROM type, where the circuit running logic is stored. The microprocessor 39 is linked, through the keyboard connector 42, to the operation panel 26 or to the same aforementioned keyboard.

For its part, the keyboard 26 has a series of applicators that are described as follows; a pulser 30 for connecting/disconnecting, a direct mode pulser 31 for paint supply towards the applying ends, and a reverse pulser 32 that recovers the paint as contained into the application hose.

The equipment running status can be determined through a luminous indicator for the direct mode 36 and a reverse mode luminous indicator 37.

The priming pulser 33 allows to set up the equipment, as per a preprogrammed mode, before commencing the work cycle that is started with the dose pulser 34.

The paint mixer is started through the pulser 35.

Being linked to the low battery indicator system and the blocked system waiting for recharging, it has been provided, for such purpose, the luminous indicator 38, with the characteristic of allowing to change its color in up to three different modes according to the needs.

Having thus specifically described and established the nature of the present invention and the way of how the same must be implemented for practical purposes, it is declared to claim as exclusive property and right:

1. An autonomous equipment for the application of paints, preferably for professional use, of the type that is connected to a paint applicator, such as a roller, sprayer or similar, for distributing the paint over a surface to be painted, being characterized by the equipment because it encompasses:
a tank that makes for a first chamber for containing paint, that presents a throat for the paint filling;
an internal tank compartment that forms a second closed chamber;
a paint suctioning/propelling bomb that has two sockets connected to a fishing tube that exits said internal tank compartment and enters into the said closed paint chamber, having on the bomb a paint outlet connected to a feeding hose that, in turn is connected to said paint applicator.
at least one impulse motor connected to said bomb;
an energy feeding source; and
a control circuit connected to the said source and to said motor, regarding said bomb, said at least one impulse motor, said control circuit and said feeding source placed into said second closed chamber of the internal tank compartment.

2. The autonomous equipment, in accordance with claim 1, characterized in that, regarding said at least one impulse motor, it comprises a first impulse motor connected to said bomb and a second impulse motor connected to a palettes mixer for paint mixing, being that said control circuit is connected to said second motor.

3. The autonomous equipment, in accordance with the claim 1, characterized in that said tank, with the said first and second closed chambers, comprises a sole weight and portable size unit, and it is made of plastic material.

4. The autonomous equipment, in accordance with claim 1, characterized in that said tank includes a transportation handle.

5. The autonomous equipment, in accordance with claim 1, characterized in that said bomb is a peristaltic bomb that comprises a replaceable flexible tubing for the paint carrying, said flexible tubing being connected, with removal possibility, to said fishing tube on one end, and to said paint carrying hose on an opposite end.

6. The autonomous equipment, in accordance with claim 1, characterized in that said tank filling throat presents a cap and a removable paint filter.

7. The autonomous equipment, in accordance with claim 1, characterized in that into said at least one motor, there is an continuous current low voltage motor, and said energy feeding source comprises a rechargeable electric battery.

8. The autonomous equipment, in accordance with claim 1, characterized in that the said fishing tube presents a lower end being submerged into paint content and that end including a paint filter.

9. The autonomous equipment, in accordance with claim 1, characterized in that said control circuit is an electronic circuit board that is connected to an operation panel.

10. The autonomous equipment, in accordance with claim 9, characterized in that said operation panel is an hermetic keyboard with touch keys.

11. The autonomous equipment, in accordance with claim 1, characterized in that between said feeding hose and said paint applicator, an extension tube is interconnected that presents an internal conduit for carrying paint from the bomb up to the applicator.

12. The autonomous equipment, in accordance with claim 1, characterized in that at the outlet of said feeding hose, there is provided a control pulser being connected to the motor through said control circuit.

13. The autonomous equipment, in accordance with claim 1, characterized in that said control circuit presents a first alarm corresponding to a first charge status of said battery, and a second alarm corresponding to a second charge status of the battery, where said first charge status corresponds to a remaining charge for a day's work of operation, while said second charge status corresponds to a near battery depletion.

14. The autonomous equipment, in accordance with claim 1, characterized in that said battery can be connected, with removal possibility, to a source charger that can be connected to a feeding line of alternating current, where the motor and the control circuit are directly fed by the source charger during a battery recharging operation.

15. The autonomous equipment, in accordance with claim 1, characterized in that said motor and bomb show a direct operation mode of paint feeding and a reverse operation mode of paint recovery.

16. The autonomous equipment, in accordance with claim 15, characterized in that there is provided a direct mode driver, in a first time period, and an activator pulser of the direct mode, in a second time period, where the first time period corresponds to equipment priming and the second time period corresponds to paint supply for consumption.

17. The autonomous equipment, in accordance with claim 16, characterized in that said driver encompasses a retention key.

18. The autonomous equipment, in accordance with claim 16, characterized in that said driver covers a pulser with a function of pre-adjustable temporization.

19. The autonomous equipment, in accordance with claim 16, characterized in that said pulser comprises a pulser of continuous pressure.

20. The autonomous equipment, in accordance with claim 16, characterized in that said pulser comprises a pulser with a function of pre-adjustable temporization.
